(19) United States
(12) Patent Application Publication
(10) Pub. No.: US 2024/0396620 A1
(43) Pub. Date: Nov. 28, 2024

(54) COMMUNICATION GATEWAY WITH IMPROVED FILTERING, RELATED AIRCRAFT, FILTERING METHOD AND COMPUTER PROGRAM

(71) Applicant: THALES, Meudon (FR)

(72) Inventors: Stéphane MONNIER, MERIGNAC (FR); Gilles DESCARGUES, TOULOUSE (FR); Alexandre NOINSKI, MERIGNAC (FR)

(21) Appl. No.: 18/671,106

(22) Filed: May 22, 2024

(30) Foreign Application Priority Data
May 25, 2023 (FR) 2305192

(51) Int. Cl. H04B 7/185; H04W 12/088

(52) U.S. Cl. CPC H04B 7/18506; H04W 12/088

(57) ABSTRACT

An avionics communication gateway including a module for acquiring at least one data message, each message being according to a communication protocol and including a header and a payload including a plurality of successive fields, a module for filtering each acquired message, validating the message if it complies with a set of filter criteria, and blocking it otherwise, and a module for transmitting, to a corresponding recipient, each validated message. The filter module includes a unit for generating a main table for each message, representing a tree of the fields of the payload of the message according to a set of levels related to the communication protocol, and a unit for calculating, for each message, a dictionary table and at least one auxiliary table from among first, second and third auxiliary tables, the filter module using the at least one auxiliary table for filtering the message.

### CROSS-REFERENCE TO RELATED APPLICATIONS

This application is a U.S. non-provisional application claiming the benefit of French Application No. 23 051932, filed on May 25, 2023, which is incorporated herein by reference in its entirety.

### TECHNICAL FIELD OF THE INVENTION

The present invention relates to an electronic communication gateway intended to be carried on board an aircraft.

The invention also relates to an aircraft comprising such a communication gateway.

The present invention also relates to a filtering method of data message(s) within an avionics communication installation intended to be carried on board an aircraft, the filtering method being implemented by such a communication gateway.

The invention also relates to a non-transitory computer-readable medium including a computer program including software instructions which, when executed by a computer, implement such a filtering method.

The invention relates more particularly to an aircraft, while being applicable to any type of aircraft, such as a helicopter or a drone.

The invention particularly relates to the field of cyber security in an avionics context.

### BACKGROUND OF THE INVENTION

Typically, an aircraft includes avionics systems allowing to assist in piloting the aircraft, such as a Flight Management System (FMS); a Flight Guidance System (FG); a Flight Control System (FCS); and so on. These avionics systems exchange information with each other thanks to an aircraft communications network, which forms part of a communications installation within the aircraft, generally including systems other than the avionics systems. In particular, the communication installation comprises systems implementing functions relating to the airline operating the aircraft, such as a Centralized Maintenance System (CMS); or a passenger cabin management system.

Avionics systems are grouped into a domain, known as the avionics domain, to which corresponds to the highest level of security required of the communications installation of the aircraft, in order to guarantee that the operation of functions implemented by avionics systems cannot be disrupted by communications with equipment outside the avionics domain. The level of security required for the other equipment is lower than the level of security required for the avionics domain.

For example, the communication system complies with the ARINC 811 standard, which defines different domains having different security levels in an aircraft communication system, in particular: an Aircraft Control Domain (ACD), corresponding to the aforementioned avionics domain; an Airline Information Services Domain (AISD) comprising equipment implementing airline-related functions (maintenance, cabin management, etc.); and a Passenger Information and Entertainment Services Domain (PIESD) for passenger entertainment and information.

In accordance with the ARINC 811 standard, the security level of the ACD domain corresponds to the highest security level of the communication system of the aircraft, since the functions implemented by the ACD domain equipment may be essential for aircraft flight control. The security level of the AISD domain is lower than that of the ACD domain, as the functions implemented in the AISD domain being less essential, at least in the short term, for aircraft flight control. The security level of the PIESD domain is lower than that of the AISD domain.

The invention therefore relates to the provision of information in the certified avionics domain, such as the ACD domain, from the uncertified open domain, in particular from the AISD domain.

The exchange of information from a domain having a lower security level to a domain having a higher security level is very highly restricted, so as not to compromise the security of the domain having the highest security level. In particular, the transfer of information from a domain, known as an open domain and corresponding to the outside of the ACD domain, toward the ACD domain is highly restricted so as not to compromise the security of the ACD domain.

To meet this need for a security gateway between the open domain and the avionics domain of higher security level, the document EP 3 585 030 A1 describes a communication gateway comprising a barrier of a first type for filtering information coming from the open domain in such a manner as to let said information enter a communication domain only if it corresponds to an authenticated communication, a barrier of a second type for filtering information transmitted from the communication domain toward the avionics domain by carrying out at least one syntactic filtering of said information. The communication gateway is also configured to carry out subsequent semantic filtering of said information.

However, such a security gateway is not optimal, particularly in terms of the processing time required to carry out the filtering.

### SUMMARY OF THE INVENTION

The aim of the invention is therefore to propose an electronic communication gateway intended to be carried on board an aircraft, allowing the processing time required for filtering to be reduced, in particular to be more effective against the risk of a cyber-attack aimed at causing avionics systems to malfunction.

To this end, the invention has as its object an electronic communication gateway intended to be carried on board an aircraft, the gateway comprising:
an acquisition module configured to acquire at least one data message; each message being according to a communication protocol and including a header and a payload including a plurality of successive fields;
a filter module connected to the output of the acquisition module and configured to filter each respective acquired message, validating said message if it complies with a set of filter criteria and blocking it as soon as a filter criterion of said set is not complied with;
a transmission module connected to the output of the filter module and configured to transmit, to a corresponding recipient, each message validated by the filter module;
the filter module including:
a generation unit configured to generate a main table for each acquired message; the main table representing a tree of the fields of the payload of said message according to a set of levels related to the communication protocol, the tree including one or more branches;
a calculation unit configured to calculate, for each acquired message, a dictionary table and at least one auxiliary table from among a first auxiliary table, a second auxiliary table and a third auxiliary table;
the dictionary table including, for each level, a list of fixed values contained in said message, each fixed value belonging to a set of predefined values related to the communication protocol;
the first auxiliary table including, for each of the levels and each fixed value of the dictionary table, an identifier for each of the field(s) containing said fixed value;
the second auxiliary table including, for each branch of the message, a list of the fixed values contained in the fields of said branch; and
the third auxiliary table including, for each level, a list of values representative of the variable values contained in said message, each variable value being distinct from the set of predefined values related to the communication protocol; and
the filter module is configured to use the at least one auxiliary table to implement the filter criteria.

With the communication gateway according to the invention, the use of at least one auxiliary table for implementing filter criteria then allows to determine much more quickly where the field or the value to which the filter criterion is to be applied is located. Indeed, each filter criterion is implemented by accessing this field or this value directly via the at least one auxiliary table, rather than having to go through the entire message, being the subject of this filtering.

Whereas the skilled person will understand that the gain in processing time is all the greater the longer the message, in other words, includes a greater amount of data in the payload of the message. For example, in the avionics domain, a flight plan forming a single message can typically present up to 64 kilobytes in size.

The gain in processing time also increases with the number of filter criteria to be applied to a single message.

The first auxiliary table allows the presence or absence of a predefined data value in the message to be detected more efficiently, and if such a value is in fact present, in addition to the number of occurrences of this value.

The second auxiliary table allows a filter to be applied more efficiently to a particular pattern of fields in the message.

The third auxiliary table allows variable values in the message to be filtered more efficiently.

In further advantageous aspects of the invention, the communication gateway comprises one or more of the following features, taken individually or in any technically possible combination:
the filter module is configured to use at least two distinct auxiliary tables from among the first auxiliary table, the second auxiliary table and the third auxiliary table to implement filter criteria;
the filter module being preferably configured to use each of the auxiliary tables from among the first, second and third tables to implement filter criteria;
the calculation unit is further configured to order according to a monotonic order the lists of fixed values of the second auxiliary table, starting by comparing the first fixed value of each of the lists, then successively moving on to the next values of said lists;
the dictionary table includes, for each fixed value, an identifier of said fixed value; and in the second auxiliary table, for each message branch, the list of fixed values is stored in the form of a list of identifiers of said fixed values;
the calculation unit is further configured to calculate each value representative of a variable value by applying an exclusive or operation (XOR) to said variable value;
the third auxiliary table further includes, for each value representative of variable values, the identifier of each of the fields containing a variable value represented by said representative value;
the aircraft includes a communication installation compartmentalized into an avionics domain and an open domain external to the avionics domain, the communication installation includes several avionics systems belonging to the avionics domain, one or more electronic devices belonging to the open domain, the gateway being able to be connected between the electronic device or devices and the avionics systems,
the avionics domain is a domain corresponding to the highest level of security on board the aircraft;
the avionics domain being preferably the ACD domain according to the ARINC 811 standard of Dec. 20, 2005.

The invention also relates to an aircraft comprising a communication installation compartmentalized into an avionics domain and an open domain external to the avionics domain; the communication installation includes several avionics systems belonging to the avionics domain, one or more electronic devices belonging to the open domain, and an electronic communication gateway connected between the electronic device or devices and the avionics systems, the communication gateway being as defined above.

The invention also relates to a method of filtering data messages within an avionics communication system intended to be carried on board an aircraft, the filtering method being implemented by an electronic communication gateway and comprising the following steps:
acquisition of at least one data message; each message being according to a communication protocol and including a header and a payload including a plurality of successive fields;
filtering of each respective acquired message, by validating said message if it complies with a set of filter criteria and blocking it as soon as a filter criterion of said set is not complied with;
transmission of each validated message to a corresponding recipient;
the filter step including the following sub-steps:
generation of a main table for each acquired message; the main table representing a tree of the fields of the payload of said message according to a set of levels related to the communication protocol, the tree including one or more branches;
calculation of, for each acquired message, a dictionary table and at least one auxiliary table from among a first auxiliary table, a second auxiliary table and a third auxiliary table;
the dictionary table including, for each level, a list of fixed values contained in said message, each fixed value belonging to a set of predefined values related to the communication protocol;
the first auxiliary table including, for each level and each fixed value of the dictionary table, the identifier of each field or fields containing said fixed value;
the second auxiliary table including, for each branch of the message, a list of the fixed values contained in the fields of said branch; and
the third auxiliary table including, for each level, a list of values representative of variable values contained in said message, each variable value being distinct from the set of predefined values related to the communication protocol; and
the at least one auxiliary table is used to implement the filter criteria.

The invention also relates to a non-transitory computer-readable medium including a computer program including software instructions which, when executed by a computer, implement a filtering method as defined above.

### BRIEF DESCRIPTION OF THE DRAWINGS

These features and advantages of the invention will become clearer on reading the following description, given solely by way of non-limiting example, and made with reference to the appended drawings, in which:

FIG. 1 is a schematic representation of an aircraft according to the invention comprising a communication installation compartmentalized into an avionics domain and an open domain external to the avionics domain; the communication installation including several avionics systems belonging to the avionics domain, one or more electronic devices belonging to the open domain, and an electronic communication gateway connected between the electronic device or devices and the avionics systems;

FIG. 2 is a schematic representation of a tree of fields of the payload of a message acquired by the gateway and of a main table generated by the gateway and representing said tree; and

FIG. 3 is a flowchart of a method, according to the invention, for filtering data message(s) within the avionics communication installation of FIG. 1, the method being implemented by the electronic communication gateway.

### DETAILED DESCRIPTION

The expressions “substantially equal to” and “of the order of” define a relationship of equality at plus or minus 20%, preferably at plus or minus 10%, and even more preferably at plus or minus 5%.

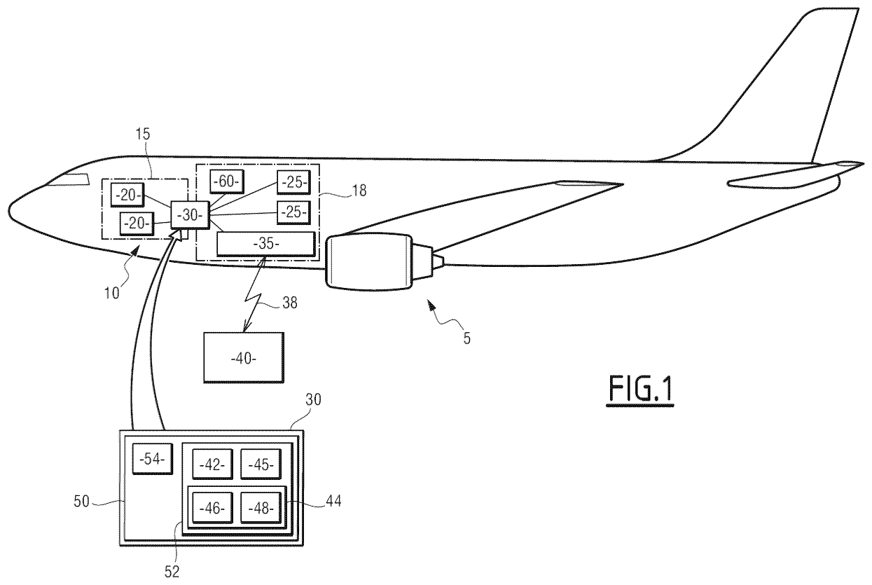

In FIG. 1, an aircraft 5 comprises a communications system 10 compartmentalized into an avionics domain 15 and an open domain 18, external to the avionics domain 15.

The communication installation 10 includes several avionics systems 20 belonging to the avionics domain 15; as well as one or more electronic devices 25, external to the avionics domain 15 and belonging to the open domain 18; and an electronic communication gateway 30 connected between the electronic devices 25 and the avionics systems 20. In the example shown in FIG. 1, the communication system 10 includes several electronic devices 25, each belonging to the open domain 18.

In addition, the communication installation 10 also comprises a communication server 35 communicating via a communication link 38 with at least one electronic device 40, external to the aircraft 5.

The avionics domain 15 is a domain corresponding to the highest security level on board the aircraft 5, in particular the highest required security level of the communication installation 10 of the aircraft 5.

The avionics domain 15 is then a domain for limiting a risk of disturbance—by at least one communication with an electronic device or apparatus external to the avionics domain 15—of functions implemented by the at least one avionics system 25 of the avionics domain 15. The avionics domain 15 includes the avionics system(s) 25.

The avionics domain 15 is typically the ACD domain according to the ARINC 811 standard of Dec. 20, 2005.

The open domain 18 is a domain with a lower security level than the security level of the avionics domain 15. The open domain 18 includes the electronic device(s) 25.

Each avionics system 20 is carried on board the aircraft 5 and belongs to the avionics domain 15. Each avionics system 20 is known per se, also referred to as an avionics computer, and is configured to implement one or more respective avionics functions.

Each avionics system 20 is, for example, selected from among the group consisting of: a Flight Management System (FMS); a Flight Guidance System (FG); a Flight Control System (FCS); a Global Navigation Satellite System (GNSS), such as a Global Positioning System (GPS); an Inertial Reference System (IRS); an Instrument Landing System (ILS) or a Microwave Landing System (MLS); a Runway Overrun Prevention System (ROPS); and a Radio Altimeter (RA).

Each electronic device 25 belonging to the open domain 18 does not implement a respective avionics function, and therefore generally does not require to be the subject of specific certification.

The electronic communication gateway 30, hereinafter referred to as communication gateway 30 or even gateway 30, is an interface between the open domain 18 and the avionics domain 15. A data message transmitted between the open domain 18 and the avionics domain 15, in other words, from the open domain 18 toward the avionics domain 15, or conversely from the avionics domain 15 toward the open domain 18, then necessarily passes through the communication gateway 30.

The communication gateway 30 is also referred to as a security gateway and is configured to carry out at least one filtering of a data message destined for a respective avionics system 20.

The communication gateway 30 comprises an acquisition module 42 for acquiring at least one data message; a filter module 44 for filtering each respective acquired message, validating said message if it complies with a set of filter criteria and blocking it as soon as a filter criterion of said set is not complied with, the filter module 44 being connected to the output of the acquisition module 42; and a transmission module 45, for transmitting, to a corresponding recipient, each message validated by the filter module 44, the transmission module 45 being connected to the output of the filter module 44. The skilled person will understand that a set of filter criteria is understood to mean a group of filter criteria, or a batch of filter criteria, in other words, a set of one or more filter criteria. The filter module 44 includes a generation unit 46 for generating a main table for each acquired message and a calculation unit 48 for calculating, for each acquired message, a dictionary table TD and at least one auxiliary table TAL, TML, TAV from among a first auxiliary table TAL, a second auxiliary table TML and a third auxiliary table TAV.

As an optional addition, the communication gateway 30 comprises an obtention module (not shown) for obtaining a set of filter parameters related to the set of filter criteria. The skilled person will understand that a set of filter parameters is understood as a group of filter parameters, or a batch of filter parameters, in other words, a set of one or more filter parameters.

The communication gateway 30 comprises, for example, an information processing unit 50 typically formed from a memory 52 and a processor 54 related to the memory 52.

According to this example, the acquisition module 42, the filter module 44 and the transmission module 45, as well as, in addition, the obtention module, are each realized in the form of software, or a software brick, executable by the processor 54. The memory 52 of the communication gateway 30 is then able to store software for acquiring at least one data message; software for filtering each respective acquired message; and software for transmitting, to a corresponding recipient, each message validated by the filtering software. As an optional addition, the memory 52 of the communication gateway 30 is able to store software for obtaining the set of filter parameters related to the set of filter criteria. The processor 54 of the communication gateway 30 is then able to execute each of the software from among, the acquisition software, the filter software and the transmission software, as well as, optionally, the obtention software.

In an alternative, not shown, the acquisition module 42, the filter module 44 and the transmission module 45, as well as the obtention module as an optional addition, are each in the form of a programmable logic component, such as a Field Programmable Gate Array (FPGA), or an integrated circuit, such as an Application Specific Integrated Circuit (ASIC).

When the communication gateway 30 is in the form of one or more software programs, in other words, in the form of a computer program, also referred to as a computer program product, it is in addition, able to be recorded on a computer-readable medium, not shown. The computer-readable medium is, for example, a medium capable of storing electronic instructions and of being coupled to a bus of a computer system. By way of example, the readable medium is an optical disk, a magneto-optical disk, a ROM memory, a RAM memory, any type of non-volatile memory (for example, EPROM, EEPROM, FLASH, NVRAM), a magnetic card or an optical card. A computer program comprising the software instructions is then stored on the readable medium.

The communication server 35 is configured to communicate via the communication link 38 with the at least one external electronic device 40, said at least one external electronic device 40 being, for example, a ground station or even a cloud computing device. The communication server 35 is preferably connected to the communication gateway 30. The communication server 35 typically belongs to the open domain 18.

The communication server 35 is known per se, and in particular includes a transceiver, not shown, compatible with the communication link 38. The communication link 38 is typically a radio link, in other words, a radio wave link, such as a satellite link. The transceiver is then a radio transceiver.

The external electronic equipment 40 is typically connected to the IT infrastructure of an Operational Control Center (OCC). The external electronic equipment 40 is then advantageously configured to transmit data, as, for example, a flight plan for the aircraft 5 and information relating to the aircraft 5, such as its weight, its configuration, its balance, or even its identifier.

The acquisition module 42 is configured to acquire at least one data message. For example, the acquisition module 42 is configured to acquire, from an electronic device 25 belonging to the open domain 18, at least one data message destined for a respective avionics system 20, belonging to the avionics domain 15. The electronic device 25, from which the message is acquired, is typically the communication server 35, if the message is transmitted from the external electronic equipment 40.

The acquisition module 42 is configured, for example, to acquire each message according to a respective avionics' communication protocol.

The avionics communication protocol is, for example, selected from among the group consisting of: a protocol compliant with the ARINC 702 standard; a protocol compliant with the ARINC 739 standard; a protocol compliant with the ARINC 619 standard; a protocol compliant with the ARINC 429 standard; and a protocol compliant with the Future Air Navigation System (FANS A) related to EUROCAE ED-100.

Each acquired data message includes a header and a payload, also referred to as payload containing the message payload, in other words, the data to be transmitted to the corresponding recipient, such as a corresponding avionics system 20.

The header typically comprises a preamble used to synchronize the message, and also including, for example, a delimiter to indicate the start of the message information; an indication relating to the destination, such as a destination address, in other words, an address or identifier of the avionics system 20 receiving the message; an indication relating to the source, such as a source address, in other words, an address or identifier of the message sender; and a check code, such as a Cyclic Redundancy Check (CRC) code.

The payload of the message includes a plurality of successive fields, the payload being divided, that is, broken down into several successive portions, each portion of the payload forming a respective field.

The filter module 44, also called filtering module, is configured to filter each respective acquired message, validating said message if it complies with a set of filter criteria, also called filtering criteria, and blocking it as soon as a filter criterion, also called filtering criterion, of said set is not complied with.

Validating the message means accepting the message, in other words, authorizing the message for transmission toward the avionics domain 15. By filtering messages via the filter module 44, the communication gateway 30 fulfills a cyber-security function. In other words, the communication gateway 30 therefore forms a security barrier between the open domain 18 and the avionics domain 15. In other words, the entry of message(s) into the avionics domain 15 is secured via the filtering carried out by the communication gateway 30, in particular by the filter module 44.

The generation unit 46 is configured to generate the main table TP for each acquired message.

The main table TP represents a tree AM of the fields of the payload of said message according to a set of levels N1, N2, N3, N4, N5 related to the communication protocol.

The set of levels N1, N2, N3, N4, N5 includes, for example, a maximum level N1, a minimum level N5 and one or more intermediate levels N2, N3, N4 between the minimum level N5 and the maximum level N1. The payload typically includes a root field of the maximum level N1, one or more leaf fields of the minimum level N5, and several intermediate fields of a respective intermediate level N2, N3, N4, each intermediate field having a single father field of higher level and one or more son fields of lower level. The payload preferably includes a single root field of maximum level N1.

The set of levels N1, N2, N3, N4, N5 is typically a set of levels related to the communication protocol, and the levels N1, N2, N3, N4, N5 are then also referred to as protocol levels.

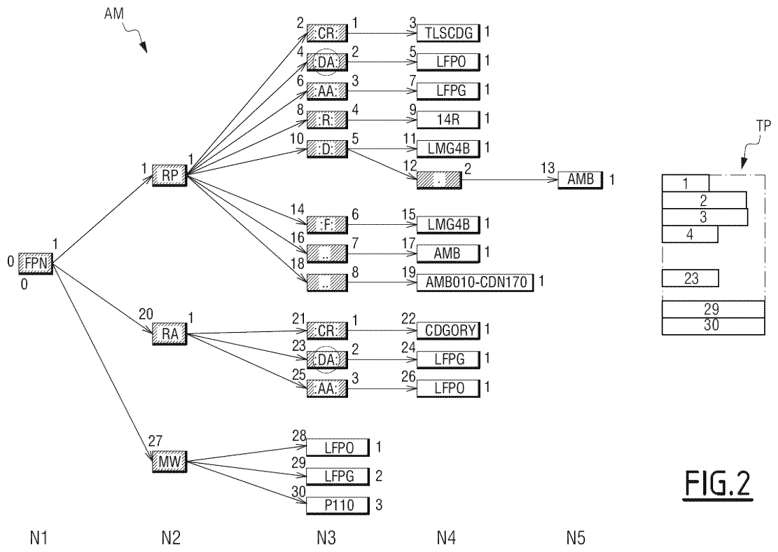

In the example shown in FIG. 2, the set of levels includes five levels, namely a first level N1 corresponding to the maximum level, second N2, third N3 and fourth N4 levels corresponding to several respective intermediate levels, and a fifth level N5 corresponding to the minimum level.

The tree AM includes one or more branches, each extending, for example, from the root field to a respective leaf field. The tree AM allows a chain of fields in the payload to be represented. By chaining, is meant, a set of one or more strings, each string corresponding to a branch. Each branch represents a respective string of fields, for example from the root field to the respective leaf field.

The generation unit 46 is typically configured to associate a respective identifier with each of the fields, then to determine the identifiers of the son field(s) of the root field, the identifiers of the father field and son field(s) of each of the intermediate fields, and the identifier of the father field of each leaf field, and to store the determined identifiers in the main table TP. The association of a respective identifier with each of the fields is carried out, for example, by numbering the fields in monotonic order, in other words, in ascending or descending order, and preferably in ascending order.

The calculation unit 48 is configured to calculate, for each acquired message, the dictionary table TD and the at least one auxiliary table TAL, TML, TAV from among the first auxiliary table TAL, the second auxiliary table TML and the third auxiliary table TAV.

According to the invention, the filter module 44 is then configured to use the at least one auxiliary table TAL, TML, TAV for the implementation of filter criteria, in other words, the implementation of at least one filter criterion.

Advantageously, the filter module 44 is configured to use at least two distinct auxiliary tables TAL, TML, TAV from among the first auxiliary table TAL, the second auxiliary table TML and the third auxiliary table TAV to implement the filter criteria. The filter module 44 is preferably configured to use the first auxiliary table TAL, the second auxiliary table TML and the third auxiliary table TAV to implement the filter criteria.

The dictionary table TD, also referred to as the lexical table, includes, for each of the levels N1, N2, N3, N4, N5, a list of fixed values contained in said message, each fixed value belonging to a set of predefined values related to the communication protocol. The dictionary table TD includes, for example, an identifier for each fixed value.

In other words, the dictionary table TD contains, for each level of the tree AM, an encoding related to the values that can be found in the message corresponding to this tree AM.

The first auxiliary table TAL includes, for each of the levels N1, N2, N3, N4, N5 and each fixed value of the dictionary table TD, an identifier for each field or fields, the fields containing said fixed value.

The first auxiliary table TAL, also referred to as the lexical access table, then offers, for each level, for each value of the dictionary table TD, direct access toward the field or fields of the main table TP containing this value of the dictionary table TD, thus allowing rapid and direct access to the elements of the message having this value of the dictionary table TD. This access typically takes the form of a pointer toward the field in the main table TP. When, for a respective fixed value of the dictionary table TD, the message does not contain a field with this value, the value ‘EMPTY’ is entered in the first auxiliary table TAL for said fixed value from the dictionary table TD.

The second auxiliary table TML includes, for each branch of the message, a list of the fixed values contained in the fields of said branch. The said list of fixed values is ordered, for example, from the root field to the respective leaf field. In the second auxiliary table TML, for each message branch, the list of fixed values is stored, for example, in the form of a list of the identifiers of said fixed values.

The second auxiliary table TML then represents a description of each branch of the tree AM, this description being done using the fixed values of the dictionary table TD.

As an optional addition, the calculation unit 48 is further configured to order, according to a monotonic order, the lists of fixed values in the second auxiliary table TML, starting by comparing the first fixed value in each of the lists, then successively moving on to the next values in said lists. This allows to facilitate the searches required by one or more filter criteria.

According to this optional addition, the second auxiliary table TML is preferably sorted in ascending order of the identifiers of the fixed values, as illustrated for example with table 3 below.

The third auxiliary table TAV includes, for each of the levels N1, N2, N3, N4, N5, a list of values representative of variable values contained in said message. Each variable value is distinct from the set of predefined values related to the communication protocol. In other words, each variable value does not belong to the set of predefined values related to the corresponding communication protocol. In other words, each variable value is a value that is not fixed by the corresponding communication protocol but must nevertheless generally respect a certain syntax. This is the case, for example, with the name of an airport in a flight plan according to the ARINC 702 protocol.

In the example shown in FIG. 2, fields with a variable value correspond to uncolored boxes, and fields with a fixed value (provided for by the communication protocol) correspond to shaded boxes.

For example, the third auxiliary table TAV also includes, for each value representative of variable values, the identifier of each of the field or fields containing a variable value represented by said representative value.

The third auxiliary table TAV, also referred to as the variable access table, then allows to have access to the variable values in the main table TP.

As an optional addition, the representative value of the variable value is not the variable value itself, but a value calculated to represent said variable value, this calculated value also being referred to as a fingerprint. This then allows, when implementing one or more filter criteria, to facilitate the search for the variable value in a set of variable values of various sizes by limiting the search for its representative value, or fingerprint. This search is further enhanced by having fixed size, sorted fingerprints, allowing dichotomous searches, for example.

Alternatively, the representative value of the variable value is the variable value itself.

According to an optional addition, the calculation unit 48 is configured, for example, to calculate each representative value of a variable value by applying an operation OR EXCLUSIVE, also noted XOR, to said variable value.

According to this optional addition, the operation XOR is applied, for example, to 32-bit words to build a fingerprint known as XORrec. This fingerprint XORrec is constituted of the XORs of successive parts of 32-bit words of the variable value. Although several variable values can have the same fingerprint XORrec, generally two distinct variable values rarely have the same fingerprint XORrec.

According to this optional addition, by way of example, the fingerprint XORec for the variable value LFPO, denoted XORec(LFPO), is then this variable value LFPO since its size is less than or equal to 32 bits. The fingerprint XORec for the variable value AMB010-CDN170, denoted XORec(AMB010-CDN170), is obtained by applying XOR operations as follows: AMBO XOR 10-C XOR DN17 XOR 0.

Preferably, the third auxiliary table TAV is sorted in monotonic order, and preferably in ascending order, of the calculated representative values.

The skilled person will observe, given that several variable values can have the same representative value, the filter module 44 is configured, so that, after identifying the field corresponding to the representative value of a variable value sought, it accesses the field identified in the main table TP in order to verify that the field identified does indeed correspond to the variable value sought, and therefore that the representative value did indeed represent this variable value sought.

By way of example, the skilled person will understand that, to search for variable values on the fourth level N4 having the value “LMG4B”, the filter module 44 searches for the representative value XORec(LM4 GB) in the fourth level N4 of the third auxiliary table TAV.

The transmission module 45 is configured to transmit to the corresponding recipient, such as the corresponding avionics system 20 each message validated by the filter module 44.

The transmission module 45 is typically configured to transmit each validated message to the corresponding recipient, according to the respective avionics' communication protocol, in other words, the avionics communication protocol corresponding to that according to which the message was previously acquired by the acquisition module 42.

As an optional addition, the obtaining module is configured to obtain the set of filter parameter(s) related to the set of filter criteria.

According to this optional addition, the filter module 44 is then configured to filter each message according to the set of filter criteria parameterized via the set of filter parameters that has been obtained by the obtaining module.

According to this optional addition, the obtaining module is configured, for example, to obtain said set of filter parameters from an electronic device 60 external to the gateway 30. Advantageously, the obtaining module is configured to verify an authentication certificate and/or a certificate of integrity for each set of filter parameters, and then to validate a respective set of filter parameters only if its authentication certificate and/or certificate of integrity are valid.

The authentication certificate allows to verify that the respective set of filter parameters is an authentic set emitted from a recognized source, and not a malicious set emitted from an attacking source. The authentication certificate is, for example, a 4096-bit RSA certificate.

The integrity certificate allows to verify that the respective set of filter parameters is a genuine set that has not been corrupted during transmission from the electronic device 60. The integrity certificate is, for example, of the Secure Hash Algorithm (SHA-2) type.

The electronic device 60 is connected to the communication gateway 30. The electronic device 60 is typically included in the open domain 18, and easily accessible by a user, to be able to store in a memory (not shown) of said device 60 new sets of filter parameters and/or modify one or more sets of filter parameters already stored in this memory. The user is typically a member of the aircraft 5 crew, such as the aircraft 5 pilot, or even an operator configuring the aircraft 5 prior to the flight.

Examples of fixed values likely to be contained in the dictionary table TD and according to the levels considered are presented below for the ARINC 702, SNMP and ARINC 739 protocols.

An ARINC 702 message is constituted of the following fields:
an Imbedded Message Identifier (IMI): this is a three-character alphanumeric string used to identify the relative content of the message, with values such as FPN, PER, LDI, POS, etc. The Imbedded Message Identifier is placed at the beginning of the ARINC 702 message and is immediately followed by the slash separator (“/”);
one or more Imbedded Element Identifiers (IEI): each IEI is a two-character alphanumeric string used to identify a group of one or more elements, with values such as FN, RP, RW, RI, RA, etc. Each IEI is immediately followed by the IEI type data, which can be a single parameter or a group of parameters. At the end of each group of elements, if an IEI follows the slash separator (“/”) is inserted between; and
a four-character end-to-end cyclic redundancy check (CRC).

For Flight Plan Initialization messages, the RP/RI/RA IEIs also contain Flight Plan Element Identifiers (FPEIs), which are special tags identifying the different types of Flight Plan Element (FPE), with values such as CR, DA, F, WS, etc. Each FPEI is immediately followed by the Flight Plan Element Identifier (FPEI). Each FPEI is immediately followed by the colon separator (“:”) and then the flight plan element data. The colon separator is also placed at the end of the flight plan element data if another FPEI follows.

For the ARINC 702 protocol, the first level N1 is then the level corresponding to the IMI, the second level N2 is that corresponding to the IEI, and the third level N3 is that corresponding to the FPEI. The fixed values likely to be contained in the dictionary table TD are also denoted “FPN”, “PER”, “LDI”, “POS” for the first level N1; “FN”, “RP”, “RW” for the second level N2; and “CR”, “DA”, “F”, “WS” for the third level N3.

By analogy, for the protocol SNMP, the fixed values likely to be contained in the dictionary table TD include “Version”, “Community”, “Request” for the first level N1; “Private”, “PDU_Type”, “ID”, “Error” “Object List” for the second level N2; and “GetReq”, “Object_ID”, “Value” for the third level N3.

Again, by analogy, for the ARINC 739 protocol, the fixed values likely to be contained in the dictionary table TD include “Line text”, for the first level N1; “Initial_charac_pos”, “Line_number”, “Function”, “Color”, “Charac” for the second level N2; and “Underscore”, “Reverse”, “Flashing”, “Black”, “0”, “Cyan”, “Yellow”, “Green”, “Magenta”, “Amber”, “White” for the third level N3.

In the example shown in FIG. 2, the tree AM shown corresponds to the following message, which is a message according to the ARINC 702 protocol:

### “FPN/RP:CR:TLSCDG:DA:LFBO:AA:LFPG:R:14R:D:LMG4B:AMB:F:LMG,N 43230E001289..AMB..AMB010-CDN170

### /RA:CR:CDGORY:DA:LFPG:AA:LFPO/MWLFBO,LFPG,P110”

where FPN specifies that it is a flight plan
RP identifies the ‘Active Route
:CR: identifies the ‘Company Route’
TLSCDG: is a variable value
DA: identifies the destination airport
FBO: is a variable value
.:identifies the ‘Direct to Waypoint’, and
AMB: is a variable value.

From this example in FIG. 2, the calculation unit 48 then calculates the dictionary table TD corresponding to the following Table 1, where the fixed values related to each level N1, N2, N3 and N4 are listed vertically by level.

TABLE 1

| N1 | N2 | N3 | N4 |
|---|---|---|---|
| 1 FPN | 1 MW | 1: AA: | 1. |
| | 2 RA | 2: CR: | |
| | 3 RP | 3: D: | |
| | | 4: DA: | |
| | | 5: F: | |
| | | 6: R: | |
| | | 7 . . . | |
| | | 8: W: | |

Still using this example from FIG. 2, the calculation unit 48 then calculates the first auxiliary table TAL corresponding to the following Table 2, where the field identifiers are indicated in brackets and listed vertically by level.

TABLE 2

| N1 | N2 | N3 | N4 |
|---|---|---|---|
| 1 (0) | 1 (27) | 1 (6) (25) | 1 (12) |
| | 2 (20) | 2 (2) (21) | |
| | 3 (1) | 3 (10) | |
| | | 4 (4) (23) | |
| | | 5 (14) | |
| | | 6 (8) | |
| | | 7 (16) (18) | |
| | | 8 EMPTY | |

By way of example, the skilled person will then observe that, for the third level N3, the value 4 of the dictionary table TD, which is related to the fixed value “:DA:” from the Table 1 above, points toward the fields 4 and 23 of the main table TP, corresponding to the two circled fields of the tree AM in FIG. 2. As another example, for the second level N2, the value 2 of the dictionary table TD, which is related to the fixed value “RA” from the Table 1 above, points toward the field 20 of the main table TP.

In the tree AM, shown in FIG. 2, the field identifiers are indicated to the left of the fields, and the values indicated to the right of certain fields represent the address of a memory cell containing a respective field, each value indicated to the right in other words forming a pointer to the memory cell containing the respective field.

From this example in FIG. 2, the calculation unit 48 then calculates the second auxiliary table TML corresponding to the following Table 3, where the sequences corresponding to the different branches of the tree AM are listed one after the other.

TABLE 3

1 1
1 2 1
1 2 2
1 2 4
1 3 1
1 3 2
1 3 3
1 3 3 1
1 3 4
1 3 5
1 3 6
1 3 7

By way of example, the skilled person will understand that the sequence “1 2 4” represents the “FPN RA:DA:” branch of the tree AM shown in FIG. 2. Indeed, in this sequence, the number 1, being in the first position in the sequence, corresponds to the first level N1. This number 1 then represents the identifier value 1 of the first level N1 of the dictionary table TD, that is, the fixed value “FPN” from Table 1 above. Next, the number 2, in the second position in this sequence, corresponds to the second level N2, and therefore represents the identifier value 2 of the second level N2 of the dictionary table TD, that is, the fixed value “RA” from Table 1. Finally, the number 4, in the third position in the sequence, corresponds to the third level N3, and therefore represents the identifier value 4 of the third level N3 of the dictionary table TD, that is, the fixed value “:DA:” from Table 1.

Still using this example from FIG. 2, the calculation unit 48 finally calculates the third auxiliary table TAV corresponding to the following Table 4, where the representative values of variable values are listed vertically by level, and the field identifier(s) related to each representative value are indicated in brackets and opposite the related representative value.

TABLE 4

| N1 | N2 | N3 | N4 | N5 |
|---|---|---|---|---|
| 1 | 1 | 1 LFPO | 1 14R (9) | 1 |
| EMPTY | EMPTY | (28) | | AMB (13) |
| | | 2 LFPG | 2 XORrec(AMB010- | |
| | | (29) | CDN170) (19) | |
| | | 3 P110 | 3 XORrec(CDGORY) | |
| | | (30) | (22) | |
| | | | 4 XORrec(TLSCDG) | |
| | | | (3) | |
| | | | 5 LFPO (5) (26) | |
| | | | 6 LFPG (7) (24) | |
| | | | 7 XORrec(LMG4B) | |
| | | | (11) (15) | |
| | | | 8 XORrec(CDGORY) | |
| | | | (22) | |

By way of example, the skilled person will observe that the representative value LFPO, which represents the variable value LFPO (of size less than or equal to 32 bits), points toward the field 28 of the main table TP for the third level N3, and toward the fields 5 and 26 of the main table TP for the fourth level N4. As another example, the representative value XORrec(LMG4B), equal to LMG4 XOR B and which represents the variable value LMG4B (of size greater than 32 bits), points toward the fields 11 and 15 of the main table TP for the fourth level N4.

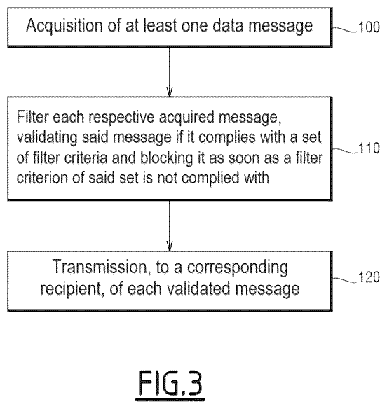

The operation of the communication gateway 30 according to the invention will now be described with reference to FIG. 3, which shows a flowchart of the data message(s) filtering method within the avionics communication installation 10, said filtering method being implemented by the communication gateway 30.

During an initial step 100, the communication gateway 30 acquires, via its acquisition module 42 and typically from a respective electronic device 25 belonging to the open domain 18, at least one data message destined for a recipient, such as a respective avionics system belonging to the avionics domain 15.

The communication gateway 30 then proceeds to the filter step 110, during which it filters, via its filter module 44, each respective acquired message, validating said message if it complies with a set of filter criteria, and blocking it as soon as a filter criterion of said set is not complied with.

During the filter step 110, for each acquired message, the generation unit 46 generates the main table TP, then the calculation unit 48 calculates the dictionary table TD and at least one auxiliary table TAL, TML, TAV from among the first auxiliary table TAL, the second auxiliary table TML and the third auxiliary table TAV. During this filter step 110, the calculation unit 48 preferably calculates the dictionary table TD, the first auxiliary table TAL, the second auxiliary table TML and the third auxiliary table TAV for each acquired message.

According to the invention, during the filter step 110, the filter module 44 then uses the at least one auxiliary table TAL, TML, TAV to implement at least one filter criterion.

Advantageously, the filter module 44 uses at least two distinct auxiliary tables TAL, TML, TAV from among the first auxiliary table TAL, the second auxiliary table TML and the third auxiliary table TAV to implement filter criteria.

Preferably, the filter module 44 uses the first auxiliary table TAL, the second auxiliary table TML and the third auxiliary table TAV to implement the global set of filter criteria. The skilled person will of course understand that the three auxiliary tables TAL, TML, TAV are not necessarily all used at the same time for each filter criterion, and that the first auxiliary table TAL is, for example, used for a first filter criterion, the second auxiliary table TML is, for example, used for a second filter criterion distinct from the first, the third auxiliary table TAV being, for example, used for a third filter criterion distinct from the first and second filter criteria. Of course, for certain filter criteria, several auxiliary tables from the first auxiliary table TAL, the second auxiliary table TML and the third auxiliary table TAV can also be used.

At the end of the filter step 110, the communication gateway 30 transmits, via its transmission module 45 and destined for the recipient, the message acquired during the acquisition step 100 if it was subsequently validated during the filter step 110, in other words, if said message complied with the set of filter criteria.

Thus, the first auxiliary table TAL, the second auxiliary table TML and/or the third auxiliary table TAV allow message filtering to be carried out with a controlled execution time. Indeed, instead of going through the message for each filter criterion to be applied, resulting in a variable execution time as a function of the size of the message and the position of the fields searched for in the message, the filter module 44 directly uses the first auxiliary table TAL, the second auxiliary table TML and/or the third auxiliary table TAV to carry out the filter criterion concerned. These auxiliary tables TAL, TML, TAV run in a much more deterministic time, as they are less sensitive to the size of the message or the location of fields in the message (whether they are at the beginning or end).

As an example of filtering, to be able to identify whether the number of ‘Direct to Waypoints’ in an ARINC 702 message does not exceed a set limit, the filter module 44, the corresponding ‘Direct to Waypoint’ value in the dictionary table TD, that is, the value “..” of the identifier 7 of the third level N3 in the dictionary table TD. From there, the filter module 44 simply determines the number of fields contained corresponding to the identifier 7 for the third level N3 in the first auxiliary table TAL, and then verifies that this number is less than the set limit. In this example, from among the three auxiliary tables TAL, TML, TAV, only the first auxiliary table TAL is used to verify whether or not this filter criterion complies, and this verification is particularly straightforward since it is sufficient to count a number of elements in this first auxiliary table TAL, then compare this number with a threshold.

The first auxiliary table TAL then allows to detect more effectively whether or not a given predefined value is present in the message, and if such a value is present, first and foremost the number of occurrences of this value.

As another example of filtering, to find out whether a particular combination of fields is present in the message, it is sufficient to see if the pattern related to this combination is present in the second auxiliary table TML. For example, to verify if the sequence “FPN RA: DA:” is present or not in the message, the filter module 44 simply determines if the sequence “1 2 4” is present in the second auxiliary table TML. In this example, from among the three auxiliary tables TAL, TML, TAV, only the second auxiliary table TML is used to verify if this filter criterion complies or not, and this verification is also straightforward, since it is sufficient to determine if a given sequence is present or not in this second auxiliary table TML.

The second auxiliary table TML thus allows a filter to be applied more effectively to a particular pattern of fields in the message.

As yet another example of filtering, to find out whether the name of a particular airport is present, the third auxiliary table TAV allows quick access to the variable values of the fourth level N4 related to names of airports having the same representative value XORrec. The filter module 44 then just verifies, by accessing the main table TP, that the name of the airport is exactly the one sought (several names may have the same representative value XORrec). In this example, from among the three auxiliary tables TAL, TML, TAV, only the third auxiliary table TAV is used to verify if this filter criterion complies or not, and this verification is once again straightforward, since all that is required is to determine if a representative value is present or not in this third auxiliary table TAV, and then carry out a complementary verification in the main table TP.

The third auxiliary table TAV thus allows variable values in the message to be filtered more effectively.

The use of at least one auxiliary table TAL, TML, TAV for the implementation of filter criteria then allows to determine much more quickly where the field or value to which the filter criterion is to be applied is located. Indeed, each filter criterion is implemented by accessing this field or value directly via the at least one auxiliary table TAL, TML, TAV, as shown notably in the previous examples, rather than having to go through the entire message being the subject of filtering each time.

The skilled person will understand that the gain in processing time is all the more important the longer the message, as is the case in avionics, where a single message can present several kilobytes in size. The gain in processing time also increases with the number of filter criteria to be applied to a single message.

It is thus conceivable that the communication gateway 30 according to the invention therefore allows the processing time required for filtering to be reduced, in particular to be more effective in the face of a risk of cyber-attack aimed at causing a malfunction of the avionics systems 20.

1. An electronic communication gateway carried on board an aircraft, the gateway comprising:
an acquisition module acquiring at least one data message, each message being according to a communication protocol and including a header and a payload including a plurality of successive fields;
a filter module connected to the output of said acquisition module and configured to filter each respective acquired message, validating the message if it complies with a set of filter criteria and blocking it as soon as a filter criterion of the set is not complied with;
a transmission module connected to the output of said filter module and configured to transmit each message validated by said filter module to a corresponding recipient;
a generation unit configured to generate a main table for each acquired message, the main table representing a tree of the fields of the payload of the message according to a set of levels related to the communication protocol, the tree including one or more branches;
a calculation unit configured to calculate, for each acquired message, a dictionary table and at least one auxiliary table from among a first auxiliary table, a second auxiliary table and a third auxiliary table, the dictionary table comprising, for each of the levels, a list of fixed values contained in the message, each fixed value belonging to a set of predefined values related to the communication protocol, the first auxiliary table comprising, for each of the levels and each fixed value of the dictionary table, an identifier of each field containing the fixed value, the second auxiliary table comprising, for each message branch, a list of the fixed values contained in the fields of the branch, and the third auxiliary table comprising, for each of the levels, a list of values representative of the variable value(s) contained in the message, each variable value being distinct from the set of predefined values related to the communication protocol, and wherein said filter module is configured to use the at least one auxiliary table to implement the filter criteria.

2. The gateway according to claim 1, wherein said filter module is configured to use at least two distinct auxiliary tables from among the first auxiliary table, the second auxiliary table and the third auxiliary table, for implementing the filter criteria.

3. The gateway according to claim 2, wherein said filter module is configured to use each of the auxiliary tables from among the first auxiliary table, the second auxiliary table and the third auxiliary table, to implement the filter criteria.

4. The gateway according to claim 1, wherein said calculation unit is further configured to order according to a monotonic order the lists of fixed values of the second auxiliary table, starting by comparing the first fixed value of each of the lists, then successively moving on to the next values of the lists.

5. The gateway according to claim 1, wherein the dictionary table comprises, for each fixed value, an identifier of the fixed value, and in the second auxiliary table, for each message branch, the list of fixed values is stored in the form of a list of identifiers of the fixed values.

6. The gateway according to claim 1, wherein said calculation unit calculates each value representative of the variable value by applying an OR EXCLUSIVE operation to the variable value.

7. The gateway according to claim 1, wherein the third auxiliary table further comprises, for each value representative of the variable value(s), the identifier of each of the fields containing a variable value represented by the representative value.

8. The gateway according to claim 1, wherein the aircraft comprises a communication installation compartmentalized into an avionics domain and an open domain external to the avionics domain, wherein the communication installation comprises several avionics systems belonging to the avionics domain, and one or more electronic devices belonging to the open domain, and wherein the gateway is connected between the electronic device(s) and the avionics systems.

9. The gateway according to claim 8, wherein the avionics domain is a domain corresponding to the highest level of security on board the aircraft.

10. The gateway according to claim 8, wherein the avionics domain is the ACD domain according to the ARINC 811 standard of Dec. 20, 2005.

11. An aircraft comprising a communication installation compartmentalized into an avionics domain and an open domain external to an avionics domain, the communication installation comprising:
several avionics systems belonging to the avionics domain;
one or more electronic devices belonging to the open domain;
and
an electronic communication gateway according to claim 1, connected between said one or more electronic devices and said avionics systems.

12. A filtering method for data message(s) within an avionics communications installation carried on board an aircraft, the filtering method being implemented by an electronic communications gateway and comprising:
acquiring at least one data message, each message being according to a communication protocol and including a header and a payload including a plurality of successive fields;
filtering each respective acquired message, comprising:
generating a main table for each acquired message, the main table representing a tree of the fields of the payload of the message according to a set of levels related to the communication protocol, the tree including one or more branches;
calculating, for each acquired message, a dictionary table and at least one auxiliary table from among a first auxiliary table, a second auxiliary table and a third auxiliary table, the dictionary table including, for each of the levels, a list of fixed values contained in the message, each fixed value belonging to a set of predefined values related to the communication protocol, the first auxiliary table including, for each of the levels and each fixed value of the dictionary table, the identifier of each field containing the fixed value, the second auxiliary table including, for each message branch, a list of the fixed values contained in the fields of the branch, and the third auxiliary table including, for each of the levels, a list of values representative of the variable value(s) contained in the message, each variable value being distinct from the set of predefined values related to the communication protocol, and the at least one auxiliary table being used to implement the filter criteria;
validating the message if it complies with a set of filter criteria;
blocking the message as soon as a filter criterion of the set is not complied with; and
transmitting, to a corresponding recipient, of each validated message.

13. A non-transitory computer-readable medium including a computer program including software instructions which, when executed by a computer, implement a method according to claim 12.
